(19) United States
(12) Patent Application Publication
(10) Pub. No.: US 2024/0289686 A1
(43) Pub. Date: Aug. 29, 2024

(54) DIRECTED MANAGEMENT OF INTERACTIVE ELEMENTS IN AN INTERACTIVE ENVIRONMENT UTILIZING MACHINE LEARNING

(71) Applicant: Microsoft Technology Licensing, LLC, Redmond, WA (US)

(72) Inventors: Gabriel A. DESGARENNES, Issaquaah, WA (US); William B. DOLAN, Kirkland, WA (US); Sudha RAO, Bothell, WA (US); Yun Hui XU, Phoenix, AZ (US); Christopher John BROCKETT, Kirkland, WA (US); Haiyan ZHANG, Redmond, WA (US)

(73) Assignee: Microsoft Technology Licensing, LLC, Redmond, WA (US)

(21) Appl. No.: 18/204,247

(22) Filed: May 31, 2023

Related U.S. Application Data
(60) Provisional application No. 63/448,950, filed on Feb. 28, 2023.

(51) Int. Cl. G06N 20/00

(52) U.S. Cl. CPC G06N 20/00

(57) ABSTRACT

The present disclosure relates to systems and methods for using a director service as an intermediary management system to integrate interactive elements between a developer, a user, a generative machine learning (ML) model, and/or an interactive environment. In examples, the director service may receive input from a user or developer device relating to an interactive element from an interactive environment. The director service may process input from one or more of the developer, the user, and the interactive environment to recognize semantic context and intent objectives associated with the input. The director service may generate one or more prompts based on such input, which is processed by an ML model to generate output. In examples, the prompts may be provided to the ML model to direct it towards providing an output that is responsive to the input and one or more environment guidelines. The input and/or output may be multimodal.

### CROSS-REFERENCE TO RELATED APPLICATION

This application claims priority to U.S. Provisional Application No. 63/448,950, titled “Directed Management of Interactive Elements in an Interactive Environment Utilizing Machine Learning,” filed on Feb. 28, 2023, the entire disclosure of which is hereby incorporated by reference in its entirety.

### BACKGROUND

As the internet and improved network capabilities have expanded in the recent past, greater emphasis has been placed on improving content offerings (e.g., video games, virtual reality, multi-modal entertainment experiences, etc.) with ongoing, realistic, and interactive elements that simulate real world interactions within the larger context of the content. But managing the interactive elements of this content is a challenging task often requiring a developer to write enormous turn-by-turn dialogue and action trees for the interactive content to be effective in user-content interaction scenarios within the content. Without consistent management and updating of the dialogue and action trees, there is a risk that the interactive content will not function correctly within the content's context. To address this problem, some developers have turned to machine learning (ML). However, such ML models may be unable to effectively interact with users to produce relevant, repeatable, and consistent results within environment guidelines, independently of designer or system management. Thus, without further advancement of technology, content designer's innovative potential is being constrained by an inability to efficiently apply the benefits of LLMs.

It is with respect to these and other general considerations that examples have been described. Also, although relatively specific problems have been discussed, it should be understood that the examples should not be limited to solving the specific problems identified in the background.

### SUMMARY

Aspects of the present disclosure relate to systems and methods for using a director service as an intermediary management system to integrate interactive elements between a developer, a user, a generative machine learning (ML) model, and/or an interactive environment. In examples, the director service may receive input from a user or developer device relating to an interactive element from an interactive environment. The director service may process input from one or more of the developer, the user, and the interactive environment to recognize semantic context and intent objectives associated with the input. The director service may generate one or more prompts based on such input, which is processed by an ML model to generate output. In examples, the prompts may be provided to the ML model to direct it towards providing an output that is responsive to the input and one or more environment guidelines. The input and/or output may be multimodal. In examples, the director service may evaluate and modify the ML model output to ensure it is responsive to the input and environment guidelines, before providing it for use to affect operation of the interactive environment.

As described, the director service in combination with the ML model may thus replace or otherwise supplement the use of comprehensive dialogue and action trees to control interactive elements effectively. The present disclosure allows an ML model to be integrated in context with substantially real-time interactive elements to perform a plurality of tasks without the need for expensive and time-consuming training to fine-tune the ML model for direct interaction. As a result of model output facilitated by the director service, aspects of the interactive environment may be adapted, thereby reducing or even removing the burden on the developer to manually develop/author aspects of environment development. Ultimately, the present disclosure provides a richer experience for users, where interactive elements are able to adapt and respond to a broader range of inputs and/or in a more realistic and creative manner within the interactive environment, while potentially reducing the amount of manual software development needed by a developer of the interactive environment.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 is a diagram illustrating a system for utilizing a director service to integrate an ML model within an interactive environment, according to aspects described herein.

FIG. 2 is a block diagram illustrating a method for integrating an ML model with an interactive environment, according to aspects described herein.

FIG. 3 illustrates an exemplary conversational agent evaluation portal, according to aspects described herein.

FIG. 4 is a block diagram illustrating a method of evaluating a ML model output using the ML model to provide the evaluation of its own output, according to aspects described herein.

FIGS. 5A and 5B illustrate overviews of an example generative machine learning model that may be used according to aspects described herein

FIG. 6 illustrates a block diagram illustrating example physical components of a computing device with which aspects of the disclosure may be practiced.

FIG. 7 illustrates a simplified block diagrams of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific examples or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

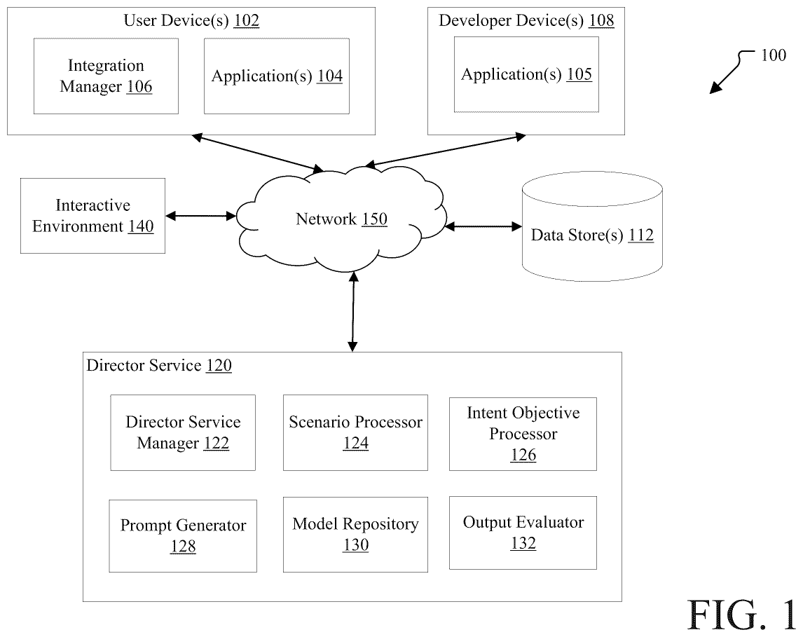

FIG. 1 is a diagram illustrating a system for utilizing a director service to integrate an ML model within an interactive environment, according to aspects described herein. In examples, system 100 includes one or more user devices 102, one or more developer devices 108, a data store 112, a director service (DS) 120, an interactive environment 140, and a network 150. The user device 102 may include one or more applications 104 as well as an integration manager 106. The developer device 108 may include one or more applications 105. The DS 120 may include a director service manager (DSM) 122, scenario processor 124, a intent objective processor 126, a prompt generator 128, a model repository 130, and an output evaluator 132. The user devices 102, developer devices 108, applications 104, applications 105, and data stores 112 are referenced as pluralities because in some examples it may be preferable to include more than one of these elements to accommodate different kinds and quantities of uses. However, for ease of discussion, the description herein refers to each element in the singular, but features and examples of each are applicable to a plurality of instances. Additionally, while DS 120 is illustrated as including a single instance of elements 122-132, it will be appreciated that any other number of such elements may be used in other examples. Further, such elements may additionally or alternatively be implemented at a variety of other computing devices, such as computing device 102.

As illustrated, the user device 102, application 104, integration manager 106, developer device 108, application 105, data store 112, DS 120, DSM 122, scenario processor 124, intent objective processor 126, prompt generator 128, model repository 130, output evaluator 132, and interactive environment 140 communicate via the network 150. The network 150 may comprise one or more networks such as local area networks (LANs), wide area networks (WANs), enterprise networks, the Internet, etc. and may include one or more of wired, wireless, and/or optical portions.

Interactive environment 140 may be a plurality of environments both physical and/or virtual, where a user and/or developer may be able to have an exchange, either verbally or non-verbally, with an interactive element of the interactive environment. In this sense, the director service 120 functions to orchestrate and integrate the interactive elements of system 100 within the interactive environment 140 according to aspects described herein. An interactive element is an aspect of the of the interactive environment 140 that can be interacted with by one or more of the user, developer, and/or DS 120. It will be understood by one having skill in the art that there are a plurality of different types of interactive environments with associated interactive elements, with non-exclusive, non-limiting examples provided herein.

An input could be a state for the interactive environment 140 as well as an implicit and/or explicit request that the system performs an operation and/or process. An explicit request might be a direct input from the user and/or developer. For example, in a gaming environment a user asking a NL question to an NPC with the expectation of some response from the NPC, in a video environment the developer requesting scene generation for a 19^{th} century American western town, in a manufacturing environment it may be a combination of an image and NL input requesting a design for a new part schematic, among many other examples. Implicit input could be some aspect of the interactive environment 140 that is collected and referenced as a trigger for a potential output. For example, in a gaming environment a user accomplishing some goal may be collected as a trigger for some celebration, in a shipping and handling environment a state of an interactive element such as a truck being empty and/or full may trigger an action, in a contact center environment an input could be the caller being passed to a certain department internally and triggering one or more disclosure statements, among many other examples. As further examples, input may include keyboard or controller input, speech and/or other audio recognition including intonation features, visual input involving gesture and/or facial expression from a user, developer, and/or other interactive element of the interactive environment 140.

The output could be a multi-modal output for an interactive element within the interactive environment 140, such as NL output associated with an NPC and/or other artificial intelligence (AI) agent, programmatic code that is executed or otherwise parsed to change some interactive element of the interactive environment 140, a texture, a schematic, part design, a schedule and/or ordering of events and/or actions, a scene or character action and/or generation, textual NL output, text to speech output, and a plurality of other examples. Thus, output can take a plurality of different forms or aspects based on one or more of the type of interactive environment 140, interactive elements involved, the type of input provided, and/or the additional processing performed by the DS 120 as described herein.

In an example, an interactive environment 140 may be a gaming environment such as a video game, online games, MMORPG, a virtual reality gaming environment, and/or other a game-like experience that may be played or otherwise experienced via user device 102 and developed and/or modified on a developer device 108. The director service 120 may be utilized to integrate gameplay with a plurality of interactive elements. Interactive elements in a game environment may be a non-player character (NPC), animated infographic, video, images, quizzes, game objects (e.g., a hammer, vehicle, building, weapon, etc.) and/or any other aspects of the interactive environment which the user/developer may be able to access and interact with.

In another example, the interactive environment 140 may be an industrial or manufacturing environment, where aspects of the present disclosure enable a user to manage an industrial or manufacturing process via a user device 102 or a developer device 108 to develop the manufacturing process. Interactive elements in this environment may be one or more automated manufacturing components or machines utilized in the process (e.g., 3D printing, CNC machines, automated handling machines, etc.), in some cases involving an aspect of machine learning and/or artificial intelligence. In this example, the director service 120 may be utilized to control and integrate the various manufacturing components to produce the desired good.

In a further example, the interactive environment 140 may be a processing facility for shipping and handling of goods with an automated management system for organizing the facility. Interactive elements in this environment may be one or more automated machines utilized in the shipping and handling process, in some cases involving an aspect of machine learning and/or artificial intelligence. In this example, the director service 120 may be utilized to integrate the shipping and handling process.

In another example, the interactive environment 140 may be scene generation for a multimedia entertainment developer. Examples of multimedia include, but are not limited to, a television show, a movie, a piece of content created for an online social networking platform, a website, and/or an application for a mobile device. The interactive elements may be a character, background setting, animated or computer-generated object within the multi-modal entertainment (e.g., a background, filter, overlay sticker), an audio file, a video file, text file, and/or any other multi-modal element singularly and/or in combination. In one instance, there may be a input/output flow between the user device 102, DS 120, and interactive environment 140 from the user of the user device 102 viewing the interactive environment 140 on the application 104, as in a social networking interactive environment. In other instances, the input/output flow occurs between the developer device 108 with application 105, the DS 120, and the interactive environment 140, as the developer creates the interactive environment 140 and/or a scene within it. For example, the multi-modal entertainment in an interactive environment 140 could be a television show, where one or more animated characters and a background setting are the interactive elements that are controlled, developed, and/or otherwise adapted utilizing a director service 120. An input could be received to generate a scene with both audio and visual elements for characters and a background. The output could be a combination of generated video, subtitles, and scripted code to run the video.

In a further example, the interactive environment 140 may be a customer service center and/or contact center, for example for offering customer support. The interactive elements in this interactive environment 140 may be one or more conversational agents that utilize the disclosed aspects to interact with users via user device 102. The director service 120 may process input (e.g., that is received via application 104 and/or application 105) and generate prompts for an ML model (e.g., of model repository 130) to generate responsive output to the input.

In another example, the interactive environment 140 may be an automated scheduling system and/or digital assistant for an individual and/or any larger entity that needs to coordinate a plurality of individual and organizational schedules, deadlines, and requirements to create a unified workflow (e.g., an airline, railway company, shipping company, university, social organization, a non-profit agency, etc.). The interactive elements in this interactive environment 140 may be the scheduling components that control one or more scheduling entities to organize them virtually.

In examples, the user device 102 and the developer device 108 may be any of a variety of computing devices, including, but not limited to, a mobile computing device, a laptop computing device, a tablet computing device, a desktop computing device, a video game computing device, a virtual reality computing device, and/or any device capable of interacting with the interactive environment 140 and director service 120.

User device 102 and/or developer device 108 may be configured to execute one or more applications, such as application 104 and/or application 105, for interacting with an interactive environment 140, and/or services and/or manage hardware resources (e.g., processors, memory, etc.), which may be utilized by users of the user device 102 and/or developer device 108. The application 104 and/or application 105 may be a native application and/or a web-based application. The application 104 and/or application 105 may operate substantially locally to the user device 102 and/or developer device 108 and/or may operate according to a server/client paradigm in conjunction with one or more servers. The application 104 and/or application 105 may be used for communication across the network 150 for the user/developer to provide input and to receive and view the output from the interactive environment 140.

Additionally, the user device 102 may have an integration manager 106, which manages the flow of information between the user device 102, director service 120, and interactive environment 140. The integration manager 106 may retain user specific data (e.g., as may be related to aspects of the interactive environment 140), which may be stored locally for later use by the director service 120. For example, in a gaming context, the integration manager 106 may retain user specific data related to previous conversation history and/or gameplay state, among other aspects of the game. Examples of the user specific data may be one or more of the input, intent objective, prompt, prompt templates, and/or model output, as described herein. The user data may be substantially local on the user device 102 and/or may be stored on a data store 112 for access by the integration manager 106 and/or director service 120. As an example, the user specific data, such as conversation history, may be utilized by the director service 120 during a subsequent conversation between an NPC and the user as context to enhance the accuracy and responsiveness of ML model outputs for NPC dialogue, according to aspects described herein. Additionally, of on-device scenarios, the integration manager 106 may manage updates for the application 104 as applicable.

Developer device 108 is substantially similar to user device 102. Variations between developer device 108 and user device 102 may involve the method of utilization for the developer device 108 as a platform for a developer, manager, and/or author of an interactive environment 140 to access and/or modify interactive elements while a user is simultaneously accessing/utilizing the interactive environment 140 and/or interactive elements within the interactive environment 140.

In an example, a user and/or developer may access the application 104 and/or application 105 on computing device 102 and/or developer device 108 to provide input. While system 100 is described in an example where input is obtained via application 104 and/or application 105, it will be appreciated that input may be obtained from any of a variety of other sources. For example, the input may be programmatically generated by application 104 and/or application 105 or may be based on the content of a file or an electronic communication, among other examples.

The user and/or developer may provide input (e.g., to the user device 102 and developer device 108, respectively) as verbal input, textual input, programmatic code, and/or as any of a variety of other input. For example, the input is provided via one or more input devices of the computing device 102 (e.g., microphone, camera, keyboard, uploading an image or video from local storage or data store 106, etc.), which are not pictured in FIG. 1.

A user/developer input may also reference previously created and/or known interactive elements (e.g., as may be stored within data store 112). In some examples, the user/developer input may include an indication of an application, data format, and/or other specification type, according to which the output is to be generated. Thus, the input may invoke an output of varying complexity based on the specificity and detail the user/developer provides.

The DS 120 is an interface to facilitate integration between the user device 102, developer device 108, ML model, interactive elements, and the interactive environment 140. In an example, DS 120 is an interface between the interactive environment 140 and an ML model (e.g., of model repository 130), such that a state of interactive environment 140 can be processed by the ML model to generate output that is thus used to affect the environment accordingly (e.g., by integration manager 106). As a result, the DS 120 may reduce the constraints/barriers associated with using machine learning to adapt aspects of an interactive environment. Further, the disclosed aspects may reduce the technical burden on a developer, as the developer need not be focused on technical aspects of the interactive environment (e.g., rules, boundaries, and/or specific mechanics) and may instead describe aspects of the interactive environment, such that the DS 120 generates model output with which the interactive environment 140 is adapted accordingly.

The DSM 122 may receive the user/developer input. The DSM 122 receives the input and performs a systemic contextual analysis to provide environment guidelines to other elements of the DS 120 accordingly. In examples, the DSM 122 may associate the input with one or more environment guidelines authored by a developer and/or the DSM 122 for the interactive environment 140. The environment guidelines provide systemic context to focus, organize, and/or constrain the available options for both prompts as well as ML model output within the intention of the developer of the interactive environment 140. In examples, the environment guidelines may be rules of varying force of application on the output, such as hard rules and/or soft rules. Hard rules carry greater force of implementation as a bright line rule, that may preclude or exclude certain types of output. For example, in a gaming context a hard rule could be that no information about the next quest can be provided until a certain task is accomplished within the game. In this example, if the user input is a repeated question to an NPC about the next quest the NPC will implement the environment guidelines including the hard rule to repeatedly provide no information about the next quest in the output. A soft rule is a rule with varying force of implementation intended to provide some level of focus, organization and/or constraint to the output. For example, in a gaming context, the soft rule may be designed to nudge the user towards a certain activity or quest based on the gameplay state. In this instance, a repeated user input of “what should I do next?” may result in an output based on the soft rule that nudges or implies to the user that a certain activity is what they should do next.

There may be a plurality of information included within the environment guidelines, such as one or more policies relative to the interactive environment 140 (e.g., toxicity policy, diversity policies, standard operating procedures, and/or any other general policies that may be relevant to the input), listings of available interactive elements, the status of various interactive elements relative to the input, etc. The environment guidelines may also include one or more NL rules for use in processing natural language input as well as for use in providing NL output. For example, in the gaming environment an NL rule may be used to prevent a potentially offensive, discriminatory, and/or hateful output by the ML model. In another example, an NL rule may exist to define the appropriate response to an offensive, discriminatory, and/or hateful input. The environment guidelines may also include a restricted list of information and/or items that is restricted from being included in a prompt to the ML model and/or as output to either the user and/or developer. The restricted list may function to protect intellectual property, protect aspects of a storyline to avoid spoilers, trade secrets, and/or any other information that the developer and/or organization associated with the information does not want exposed beyond a certain access level. In some examples, the DSM 122 may utilize one or more NL processing tools, rule-based analysis, and/or ML models to analyze one or more portions of the input and define appropriate environment guidelines and scheduling functions, as described herein.

In examples, the environment guidelines may be a listing and/or systemic information that is applied to each input. In other examples, the environment guidelines may be structured as a tree with nodes and branching logic, where a node could have a set of associated environment guidelines that determines what should be provided along with the input (e.g., whether an objective has been achieved such that the user progresses, etc.) and/or whether prompt generation should be “nudged” and/or directed in a certain manner.

The environment guidelines may vary based on the type of interactive environment 140 with which the director service 120 is utilized. For example, if the interactive environment 140 is a gaming environment and the input corresponds with an NPC, the environment guidelines identified by the DSM 122 with which to generate output may include a toxicity policy restricting the output and may thus, for example, define one or more acceptable responses for certain types of inputs. The environment guidelines may also include systemic gameplay parameters for the gaming environment, for example beyond the scope of the user specifically, which may be relevant for informing prompts to the ML model, among other things.

The scenario processor 124 collects and analyzes specific context that may be used for prompt generation, for example as it relates to one or more of the input, for a user/developer, and/or one or more interactive elements within the interactive environment 140, among other aspects of specific context. Thus, the scenario processor 124 may access one or more contextual indicators associated with the interactive environment 140 before, during, and/or after the input is received to provide the intent objective processor 126 and prompt generator 128 with contextual indicators with which to generate a prompt. Thus, the scenario processor 124 may use one or more tools (e.g., NL processing tools, expanded focus tracking with sentiment, video/image analysis and processing tools, ML models, etc.) to generate or otherwise obtain contextual information relating to the various interactive elements and contextual indicators relating to the interactive environment 140. The specific context that will be gathered will vary based on the interactive environment 140 utilizing the DS 120. In some examples, the scenario processor may perform function and/or action tracking of the user/developer and interactive elements within the input scenario of the interactive environment 140. In this sense, an action may be either an input to the DS 120 and/or an output from an interactive element (e.g., a manufacturing component initiating a process would need to be tracked, a vehicle departing from a shipping location may be an action that needs to be tracked, a NPC in a video game may throw an object into the ocean in response to a input which would need to be tracked, etc.).

For example, in a gaming context, the scenario processor 124 perform an expanded focus tracking with sentiment analysis of the user character as well as other players, NPCs, and/or other objects and interactive elements within the input scene. These specific contextual indicators may include audio and/or visual indicators from the player's character (e.g., the player's facial expression, tone, posture, hand movements, etc.), from the interactive environment 140 (e.g., battle noises, laughter or silence in the environment, the facial features of the user's companions in the game, etc.), and/or from the game state (e.g., in a sports game the time remaining in the match, location on the field, penalties, etc.) among other indicators. Additionally, the scenario processor 124 may access or otherwise obtain specific context (e.g., from the integration manager 106 and/or the data store 112) related to the user's game state (e.g., game progress, goal tracking and completion, user game level, user experience, user tools and/or equipment available, etc.), and/or any other information relevant to the user's game play. If the user is participating in a team scenario (e.g., team quest, sports game, racing game, etc.), or interacting with interactive elements that have certain game state associated with them, the scenario processor may also gather similar specific context related to the user's teammates game state as well.

Continuing the gaming example, the scenario processor 124 may also utilize recent and past conversation/interaction history between the user, the interactive element, and/or optionally teammates to inform the prompts and progress the interaction between the user and the interactive element. For example, over a multi-turn interaction, the NPC may be directed by the DS 120 based in part on the specific context associated with a conversation history to say within the game context to say “I've told you 100 times already” in response to a repetitive input. The specific context can be used for a variety of purposes in gameplay, such as providing hints and/or other conversation nudges to move the user in the direction of completing their next goal and/or task. In another example, the specific context of the user's game state and player level may be utilized to prevent the user from receiving information in an output that might provide insight into gameplay that the user does not have access to yet.

As another example, in a contact center interactive environment, the input may include audio information relating to the tone of the user's voice and/or the facial features of the user, if available, indicating an emotional state (e.g., angry, frustrated, happy, understanding, confused, etc.). The specific contextual indicators which may be gathered by the application 104 and/or application 105 and/or the director service 120 in addition to the directly provided input serve the purpose of providing additional contextual information which can be utilized to refine and improve prompt generation.

Further, the scenario processor 124, may store one or more of the user/developer input, intent objective, prompts, prompt templates, and model output in data store 106 as semantic context and/or known interactive elements (e.g., in instances where the model output generates a new and/or modifies an existing interactive element) which may be utilized for subsequent input analysis. In examples, the scenario processor 124 may utilize one or more ML models trained to identify specific context or intents, a rules-based process to identify context based upon the received input, or any other type of application or process capable of parsing and analyzing input to determine context and/or intent based upon the user/developer input.

A intent objective processor 126 receives one or more of the input, systemic context and environment guidelines from the DSM 122, and/or specific context from the scenario processor and utilizes it to determine one or more a intent objectives associated with the input. Once determined, the intent objectives encapsulate the general intent, requested task, and/or specific meaning of the input and may be utilized to assist in generating one or more prompts related to that intent objective. To generate the intent objective, the intent objective processor 126, analyzes one or more of the input, systemic context, specific context, and/or environment guidelines. In an example, the intent objective processor 126 may use a rules-based approach, wherein the input, systemic context, specific context, and/or environment guidelines are analyzed based on a series of rules to determine a intent objective. In another aspect, a semantic encoding model may be utilized to determine the semantic context associated with the input, systemic context, specific context, and/or environment guidelines to determine a intent objective. The semantic encoding model may determine one or more semantic portions of the input, systemic context, specific context, and/or environment guidelines, and process the semantic portions to generate one or more intent objectives that describe the intent underlying the user/developer input.

In a further example, the input, systemic context, specific context, and/or environment guidelines are processed to determine a intent objective based on the language used in them. In an example, a intent objective may be determined by an program that processes the input, systemic context, specific context, and/or environment guidelines. In an additional embodiment, one or more embeddings may be utilized to determine an intent objective. An embedding may be generated for the input, systemic context, specific context, and/or environment guidelines, such that a single embedding describes the elements of each. Alternatively, an embedding may be generated singularly and/or for one or more portions of each of the input, systemic context, specific context, and/or environment guidelines based on the granularity desired within the system. The embeddings may then be utilized to identify one or more semantically associated intent objectives from a data store 112 which in this instance may be configured as an embedding object memory. The semantically associated intent objectives may then be analyzed and refined to determine a one or more intent objectives for the input.

Additionally, the intent objective processor 126 may be able to query against data structures (e.g., as may be maintained within the data store 112 and/or integration manager 106) to determine and/or gain further context into an element of the input. This allows for a request-and-generate type completion to input via queries to a database 112 of known information that can be utilized to create a intent objective rather than relying on potentially false information. For example, the intent objective processor 126 may be able to retrieve a recipe associated with the input, check for a fact, reference a known object and/or other piece of stored information relevant to the input. The type of information that the intent objective processor 126 may have access to and/or may look for will vary based on the interactive environment 140. For example, in a shipping and handling and/or a scheduling environment, the intent objective processor 126 may need to reference the storage capacity of a particular vehicle (e.g., truck, airplane, storage container, ship, etc.) to process an input asking, “how much will it cost to move 5000 SUVs from Mexico to Canada?” In a gaming environment, if input is a question to an NPC asking, “where are my teammates?” the intent objective processor 126 may need to reference game state information maintained in the integration manager 106 to identify who would be the user's teammate and the teammate's current locations within the data store 112 to define the intent objective. It will be appreciated by one having skill in the art of the numerous examples which are possible based on the type of interactive environment 140.

Prompt generator 128 may receive one or more of the input, systemic context, specific context, environment guidelines, and/or the intent objectives and utilize them to generate one or more prompts for the ML model. The prompt generator 128 may generate one or more prompts that, when processed by an ML model, cause the ML model to generate output responsive to the one or more intent objectives associated with the input, with which the interactive environment may be adapted according to aspects described herein. That is, the generated prompts enable a ML model to process the context associated with an input which would otherwise be unknown to it. Thus, the one or more prompts are utilized by the ML model to generate output responsive to the input without requiring additional training or fine-tuning of the ML model prior to generating model output. In this sense, an output may be one or more of a text file, an audio file, an image, a video, a NL output (e.g., verbal and/or non-verbal), programmatic language (e.g., code), and/or any other type of output which may cause an interactive element of the interactive environment 140 to act in a way that is responsive to the user/developer input within the context provided by the DS 120.

Additionally, the prompt generator 128 may evaluate the input, systemic context, specific context, and/or environment guidelines to determine if a portion or all of the input is a known intent objective. Known intent objectives may have an associated prompt stored in the data store 112, and/or a general ML model may be able to process the intent objective directly without requiring new prompt generation. This allows for a request-and-generate type completion to input via queries to a database 112 of known prompts rather than generating a potentially false prompt. If the input contains one or more known prompts, the prompt generator 128 may retrieve the known prompt from data store 112 and/or integration manager 106 and, if additional prompt generation by prompt generator 128 is not required, may pass the known prompt to the ML model for processing. If an additional prompt generation is required, the prompt generator 128 may generate the additional prompts according to aspects described herein, and pass both the generated and known prompts to the ML model for processing

In some examples, a prompt may be comprised of a plurality of prompt templates. A prompt template may include any of a variety of data, including, but not limited to, natural language, image data, audio data, video data, and/or binary data, among other examples. In examples, the type of data may depend on the type of ML model that will be leveraged to respond to the received input. One or more fields, regions, and/or other parts of the prompt may be populated with one or more prompt templates encompassing input and/or context, thereby generating a prompt that can be processed by an ML model of the model repository 130 according to aspects described herein.

In an additional example, a prompt template includes known entities, previously stored objects, and/or previously known prompt templates that were previously created or input to the system 100, thereby enabling a user to reference previously created model output and/or any of a variety of other content for further use. For example, data store 112 and/or integration manager 106 may include one or more embeddings associated with previously generated model output and/or previously processed input, thereby enabling semantic retrieval of the prompt template and associated context (e.g., such that previously generated model output may be iterated upon). In some aspects this may include selecting the most relevant part of a previously generated prompt and utilize that as the input to the ML model. In some instances, a small portion of a previously known prompt template may be sufficient to generate responsive model output without requiring full prompt generation.

In some aspects, the prompt generator 128 may utilize the one or more prompts in place of the input to the ML model. In another example, the prompt generator 128 may provide the one or more prompts in addition to the input. The prompts may be generated in a variety of ways. In one example, an application and/or ML model from model repository 130 may analyze the intent objective and input to select from one or more prompt templates stored in data store 106 and/or integration manager 106 with which to populate the prompt. In an alternative example, NL processing tools may be utilized to analyze the input and intent objective to determine one or more associated prompt templates and populate a prompt.

In another aspect, the prompt generator 128 may associate one or more prompt templates with at least a portion of the input and/or intent objective and populate each prompt template to generate one or more prompts accordingly. The prompt templates may contain semantic information that, when combined into a prompt, encapsulate specific context used by the ML model to generate model output in response to the input. The one or more prompt templates may be retrieved from data store 112 and/or integration manager 106, by the prompt generator 128. In another example, an embedding may be generated for the input and/or intent objective singularly and/or collectively. The one or more embeddings may be stored in a data store 112 and/or integration manager 106 for future use. The embedding may be used to identify semantically associated prompt templates from a data store 106, that is designed as an embedding object memory. The one or more semantically associated prompt templates may be used to generate one or more prompts that will be processed by one or more ML models from the model repository 130. In further embodiments, a ML model stored in model repository 130 may be trained or otherwise used to generate prompts. In this example, the trained ML model may be utilized to process the one or more of the input, systemic context, specific context, environment guidelines, and/or the intent objectives and output one or more prompts responsive to the input.

In some examples, the prompt generator 128 may include a summarization function that will control the length of the prompt. In certain examples, the ML model may have a token or other input limit that may prevent overly long prompts from being input to the ML model. In this case, the prompt generator 128 may modify the prompt to reduce the length of the prompt to prevent overflow and reduce token cost. In some examples, this may involve summarizing one or more portions of the prompt.

In some examples, the prompt generator 128 may also be utilized to compare the prompts to the environment guidelines and determine if they satisfy the environment guidelines, including to protect certain aspects for intellectual property from being exposed to the ML model. If an aspect of the prompt does not satisfy the environment guidelines, then the prompt generator 128 may modify the prompt and/or data mask certain information either prior to ML model input and/or through a later analysis of the ML model output. The data masking may be performed in conjunction with the environment guidelines including the restriction list as discussed above. The data masking may occur such that certain information is not allowed to be included in a prompt and potentially exposed to the background ML model utilized to generate the responsive output.

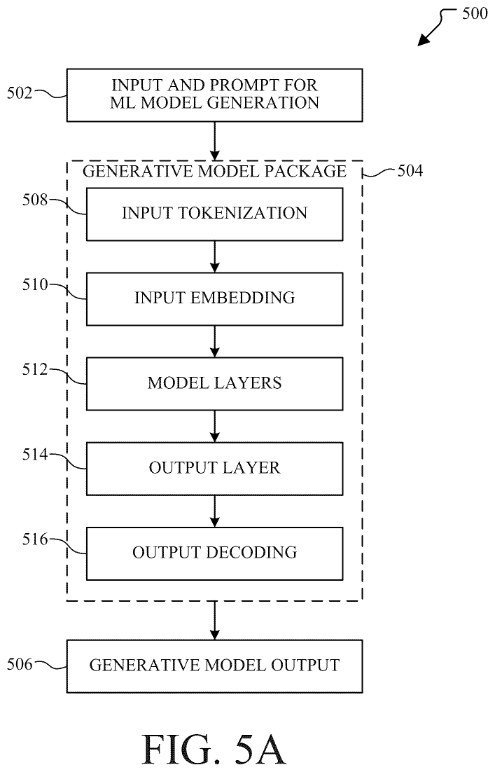

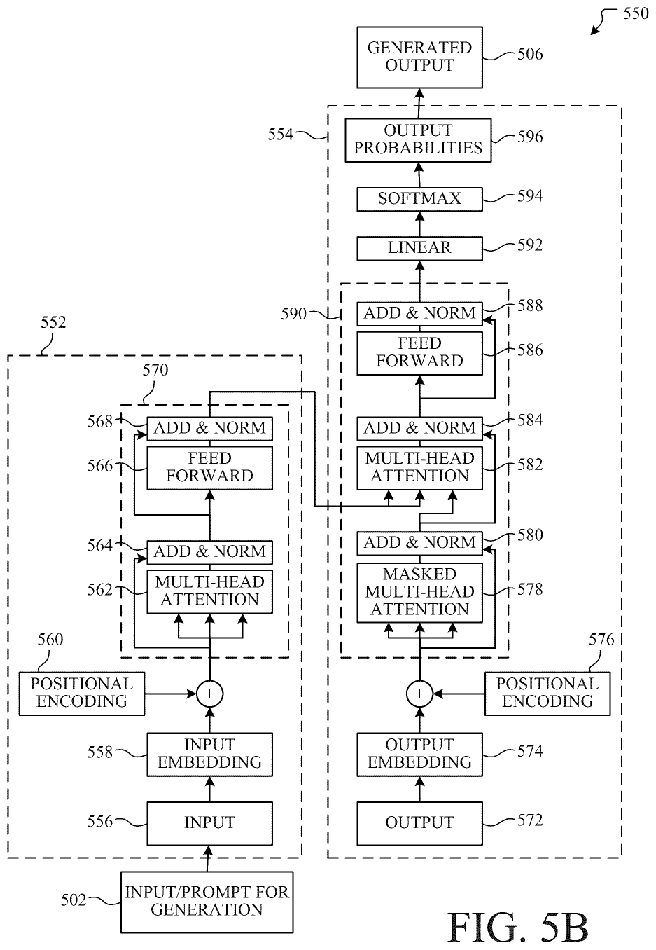

As illustrated, the director service 120 includes model repository 130 which may include any of a variety of ML models. A generative model (also generally referred to herein as a type of ML model) used according to aspects described herein may generate any of a variety of output types (and may thus be a multimodal generative model, in some examples) and may be a generative transformer model, a large language model (LLM), and/or a generative image model, among other examples. Example ML models include, but are not limited to, Generative Pre-trained Transformer 3 (GPT-3), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B. Additionally or alternatively, one or more recognition models (or any of a variety of other types of ML models) may produce their own output that is processed as part of a skill chain according to aspects described herein.

Output evaluator 132 may receive the output from the ML model and evaluate it for responsiveness to the input, as well as ensure it satisfies the environment guidelines from the DSM 122. In this case, the responsiveness evaluation determines if the output will produce a result in an interactive element of the interactive environment 140 that satisfies the input. In examples, the output may be responsive and satisfy the environment guidelines in case it will be returned to either the integration manager 106, application 104, and/or application 105 for use in the interactive environment 140. In some examples, prior to returning the output to the user, the output evaluator 132 may determine that the output is inadequate to the input and/or not responsive to the input. In some examples, this may be the result of the output failing to exceed a predetermined confidence threshold or due to an indication of an error or other issue that is received (e.g., as a result of processing of at least a part of the output, as may be the case when the output includes code or other output that is syntactically incorrect or otherwise malformed), among other examples. If a confidence threshold is utilized, the output evaluator 132 may receive a confidence threshold from a developer, score the output based on one or more evaluation metrics, and then compare the output score to the threshold.

In some examples, the evaluation may generate a single confidence score for the entire output and/or a confidence score for individual components of the output, where the confidence score represents responsiveness of the output or component of the output to the input, as well as ensure it satisfies the environment guidelines. In some examples, this may be performed by generating one or more confidence scores for one or more components of the output individually and comparing the one or more confidence scores to a threshold value. The confidence score may be determined using evaluation metrics developed for the ML model and the output. The component confidence score may be a measure of the output's responsiveness to the input and how well the output satisfies the environment guidelines based on the one or more evaluation metrics. For example, in a scene generation scenario the output may include elements of generated video, subtitles corresponding to the generated video, an audio component corresponding to the video, and/or scripted code to run the video, subtitles, and/or audio component. A confidence score may be generated for each component of the output (e.g., video, audio, subtitles, and/or scripted code) and evaluated by comparison to the threshold value for responsiveness to the input and how well the output satisfies the environment guidelines based on the one or more evaluation metrics. In further examples, the individual component confidence scores could also be combined into a combined confidence score and compared to a threshold value as well, to further evaluate the output.

If the output fails, the output evaluator 132 may reinitiate the process for generating the output such that another output is created. In other examples, the output evaluator 132 may provide a failure indication to application 104 and/or application 105 for display to the user and/or developer, for example indicating that the user/developer may retry or reformulate the input, that the input was not correctly understood, or that the requested functionality may not be available. While example issues and associated issue handling techniques are described, it will be appreciated that any of a variety of other issues and/or issue handling techniques may be encountered/used in other examples.

In some instances, the output evaluator 132 may determine that the output does not satisfy the environment guidelines. This may be the result of the output containing too much information that should not be conveyed to a user (e.g., in a gaming scenario, this could result in a gameplay spoiler, in a plurality of scenarios there may be an aspect of intellectual property included in the output which should be excluded, there may be an aspect of the output which does not satisfy the toxicity policy of the interactive environment 140, etc.). One or more NL processing and/or other techniques may be utilized to analyze the output in order for the determination to occur. In such an instance the output evaluator 132 may, if possible, modify the output to remove or data mask the element within the output which does not satisfy the environment guidelines. As another example, the output evaluator 132 may reinitiate the process of generating a prompt and output according to aspects described herein.

In example, the output evaluator 132 may include an option to receive feedback from the user device 102 and or developer device 108 relative to the output received and performed by an interactive element. In some instances this feedback may be received via a conversational agent evaluation portal, such as a chat window and/or other user interface, that allows the user/developer to provide feedback on the experience with the interactive element and the responsiveness of the output provided. In this instance, the user/developer may be interacting with a human counterpart to respond to a series of questions to provide feedback. In other instances, the user/developer may interact with a conversational agent which may utilize one or more aspects of an ML model to engage in the feedback session. Additionally, or alternatively, feedback may be obtained via implicit signals associated with user interaction with the environment.

In further instances, the output evaluator 132 may query the ML model that produced the output directly, asking the ML model to generate output relative to its responsiveness to the input and/or whether it satisfies the environment guidelines. In this instance the output evaluator 132 may direct the prompt generator 128 to generate one or more prompts to provide to the ML model, process the one or more prompts, and provide output where the model explains why it provided the output and why the model considers the output to be responsive and satisfactory. This feedback conversation history may be stored in a data store 112 and/or fed back into the ML model as one or more prompts so that it may improve and refine its process by evaluating its own behavior and output. In some instances one or more metrics may be developed and provided to the output evaluator 132 and/or the ML model to further refine and improve the feedback and evaluation process.

In another example, the conversational agent evaluation portal may be utilized outside the interactive environment 140 to evaluate the effectiveness of the model by giving a user/developer access to one or more interactive elements that are connected to the DS 120. In this instance, to evaluate the ML model, the user/developer can provide an input, in the form of a chat, to interact with the interactive element (e.g., an NPC, a scheduling system, etc. based on the type of interactive environment). In examples, the user/developer may fill out a survey where they will answer questions that evaluate the interactive element responses. The feedback may be used to update prompt generation, ML model output, and/or other aspects of the DS 120 with user/developer implicit feedback.

In an example, input may be provided at a user device 102 and/or a developer device 108 via an application 104 and/or application 105 and transmitted to the DS 120 for the purpose of producing model output responsive to the input. In examples, the input may be received, for example, in a chat function of application 104 and/or application 105 used for interacting with a ML model in model repository 130. In some aspects, the input may be a natural language (NL) input provided as speech input, textual input, and/or as any of a variety of other inputs (e.g. text-based, images, video, etc.) via the input devices of the user device 102 and/or developer device 108 (e.g., microphone, camera, keyboard, uploading an image or video from local storage or data store 112, etc.) which are not pictured in FIG. 1. Additionally, or alternatively, input may be programmatically generated by application 104 and/or application 105, may be based on the content of a file or an electronic communication, may comprise an image, other data type, and/or a plurality of other examples which will be understood by one having skill in the art. In some instances, the input may reference previously created entities or known entities (e.g., as may be stored within data store 112). It will be appreciated that the input need not be in a particular format, contain proper grammar or syntax, or include a complete description of the model output that the user intends the ML model to generate. While the amount of detail provided with the input may improve the resulting model output, sparse input is sufficient.

In aspects, the user device 102 and/or developer device 108 may be a mobile computing device, a desktop computing device, a virtual reality device, a gaming device, and/or a vehicle computer. User device 102 and/or developer device 108 may be configured to execute one or more design applications (or “applications”) such as application 104 and/or application 105 and/or services and/or manage hardware resources (e.g., processors, memory, etc.), which may be utilized by users of the user device 102 and/or developer device 108. The application 104 and/or application 105 may be a native application or a web-based application. The application 104 and/or application 105 may operate substantially locally to the user device 102 and/or developer device 108, or may operate according to a server/client paradigm in conjunction with one or more servers (not shown). The application 104 and/or application 105 may be used for communication across the network 150 for the user to provide input and to receive and view the model output from the DS 120.

The user device 102 and/or developer device 108 can receive send and receive content data as input or output which may be, for example from a microphone, a camera, a global positioning system (GPS), etc., that transmits content data, a computer-executed program that generates content data, and/or memory with data stored therein corresponding to content data. The content data may include visual content data, audio content data (e.g., speech or ambient noise), a user-input, such as a voice query, text query, etc., an image, an action performed by a user and/or a device, a computer command, a programmatic evaluation gaze content data, calendar entries, emails, document data (e.g., a virtual document), weather data, news data, blog data, encyclopedia data and/or other types of private and/or public data that may be recognized by those of ordinary skill in the art. In some examples, the content data may include text, source code, commands, skills, or programmatic evaluations.

The user device 102, developer device 108, and/or DS 120 may each include at least one processor that executes software and/or firmware stored in memory. The software/firmware code contains instructions that, when executed by the processor causes control logic to perform the functions described herein. The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the examples, various logic may be implemented in any appropriate fashion and would remain in accordance with the examples herein disclosed

In accordance with some aspects, the user device 102 and/or developer device 108 and DS 120 may have access to data contained in a data store 112, as well as the ability to store data in data store 112. The data store 112 may contain a plurality of content related to generating an output and providing data to an ML model. Data store 112 may be a network server, cloud server, network attached storage (“NAS”) device, or another suitable computing device. Data store 112 may include one or more of any types of storage mechanism or memory, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. In some instances, the data store 112 may be configured as an embedding object memory. Although only one instance of the data store 112 are shown in FIG. 1, the system 100 may include two, three, or more similar instances of the data store 112. Moreover, the network 150 may provide access to other data stores similar to data store 112 that are located outside of the system 100, in some examples.

In some examples, the network 150 can be any suitable communication network or combination of communication networks. For example, network 150 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, network 150 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

As will be appreciated, the various methods, devices, apps, nodes, features, etc., described with respect to FIG. 1 or any of the figures described herein, are not intended to limit the system to being performed by the particular apps and features described. Accordingly, additional configurations may be used to practice the methods and systems herein and/or features and apps described may be excluded without departing from the methods and systems disclosed herein.

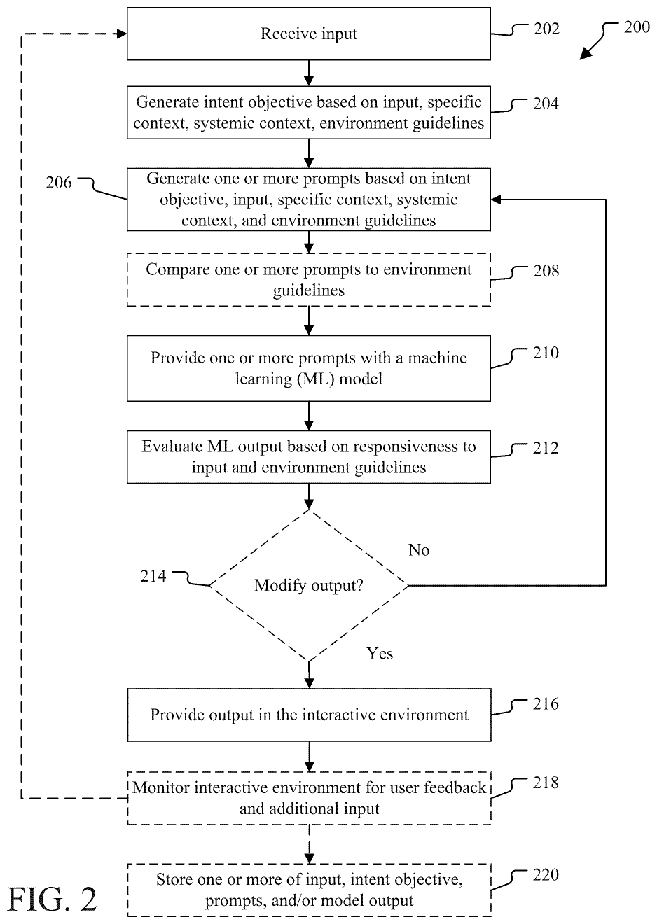

FIG. 2 is a block diagram illustrating a method for integrating an ML model with an interactive environment, according to aspects described herein. A general order of the operations for the method 200 is shown in FIG. 2. Generally, the method 200 begins with operation 202 and ends with operation 216. The method 200 may include more or fewer steps or may arrange the order of the steps differently than those shown in FIG. 2. The method 200 can be executed as computer-executable instructions executed by a computer system and encoded or stored on a computer readable medium or other non-transitory computer storage media. Further, the method 200 can be performed by gates or circuits associated with a processor, an ASIC, an FPGA, a SOC or other hardware device. Hereinafter, the method 200 shall be explained with reference to the systems, components, devices, modules, software, data structures, data characteristic representations, signaling diagrams, methods, etc., described in conjunction with FIGS. 1, 3, 4, 5A, 5B, 6, 7, and 8.

At operation 202, input is received. The input may be received from an application (e.g., application 104 and/or application 105) and/or an integration manager (e.g., integration manager 106) on a computing device (e.g., user device 102 and/or developer device 105). The input may indicate a request for model output. The input may also include information collected by a DS (e.g., DS 120) and/or integration manager (e.g., integration manager 106) including systemic context and/or environment guidelines from a DSM (e.g., DSM 122), as well as specific context from a scenario processor (e.g., scenario processor 124).

At operation 204, a intent objective may be generated, for example, by a intent objective processor (e.g., intent objective processor 126) based on one or more of the input, specific context, systemic context, and/or environment guidelines. The intent objective may encapsulate the general intent or specific meaning of the input and may be utilized to assist in generating one or more prompts specifically related to that objective.

At operation 206, one or more prompts are generated based on the by a prompt generator (e.g., prompt generator 128). A prompt is generated based on one or more of the input, environment guidelines, systemic context, specific context, and/or intent objective corresponding to the interactive environment (e.g., interactive environment 140) for which the input was received. In some instances, the prompts may be a known prompt in which case the prompt generator may access them from a data store (e.g., data store 112) and/or an integration manager (e.g., and/or integration manager 106). The prompts are utilized to provide sufficient context to a general ML model so that it can generate model output responsive to the input.

At operation 208, the prompt generator (e.g., prompt generator 128) may compare the one or more prompts to the environment guidelines and if they do not satisfy the guidelines may modify one or more portions of the prompt and/or data mask a portion of the prompt so that the prompt does satisfy the environment guidelines. Operation 208 is shown as a dashed box to indicate that it is optional and may be omitted in certain examples.

At operation 210, the one or more prompts are processed by a ML model, such as, for example, a generative large language model (LLM), that is part of a model repository (e.g., model repository 130).

At operation 212, the model output may be evaluated by an output evaluator (e.g., output evaluator 132) to determine if the output is responsive to the input and satisfies the environment guidelines. In some cases by the evaluation may be performed by generating a confidence score for one or more components of the output and comparing the one or more confidence scores to a threshold value. The confidence score may be determined using evaluation metrics developed for the ML model and the output. The confidence score may be a measure of the output's responsiveness to the input and how well the output satisfies the environment guidelines based on the one or more evaluation metrics. At operation 214, the output evaluator may attempt to modify one or more aspects of the model output and/or data mask portions of the output to make the output responsive to the input and/or the guidelines as required. If the model output is not responsive and cannot be modified, flow progresses to operation 206 where a new prompt may be generated. The new prompt may be refined either by a new method of generating a prompt and/or by broadening or narrowing the parameters of a previously used method of generating prompts, as described above. The new prompt will be input to the ML model to generate a new model output. This loop will continue until the model output is determined to be responsive to the input and environment guidelines. If the model output is responsive flow progresses to operation 216, where the model output is provided to the user and/or developer by the DSM (e.g., DSM 122). Operation 214 is shown with a dashed line to indicate the step is optional and may be omitted in certain examples, such as when the output is responsive at step 212.

At operation 218, the DS (e.g., DS 120) monitors the interactive environment for user and/or developer feedback as well as additional input from either the user and/or developer, which may be received via the application (e.g., application 104 and/or application 105) and/or via a conversational agent evaluation portal. If additional feedback and/or input is received then flow progresses to operation 202 for further processing of the input as described above. Operation 218 and the line from operation 218 to 202 are shown with dashed lines to indicate they are optional and may be omitted in certain examples. For example, in a gaming context

At operation 220, one or more of the input, intent objective, one or more prompts, and/or model output are stored in a data store (e.g., data store 112) and/or an integration manager (e.g., integration manager 106). Operation 220 is shown with a dashed line to indicate the step is optional and may be omitted in certain examples.

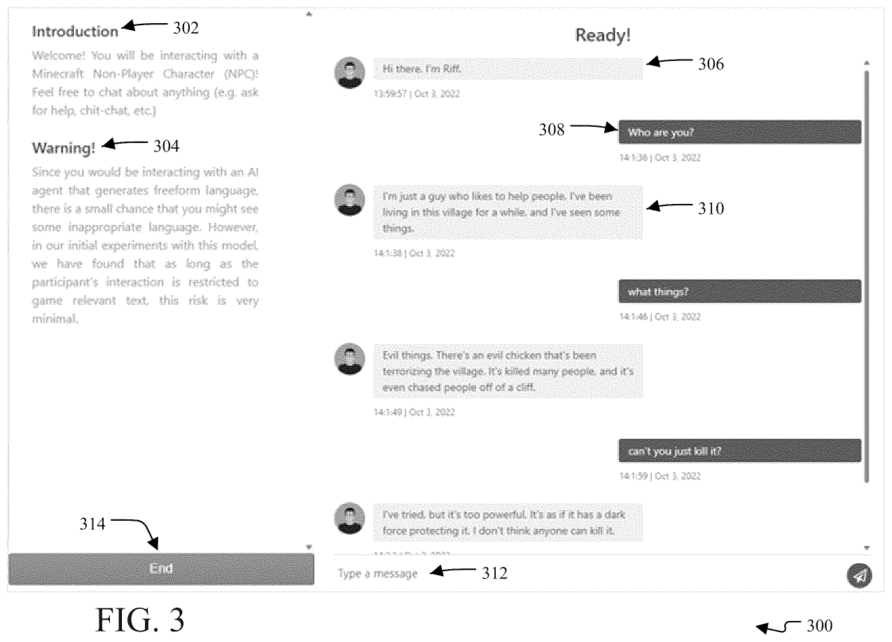

FIG. 3 illustrates an exemplary conversational agent evaluation portal, according to aspects described herein. The conversational agent evaluation portal may be provided by an output evaluator (e.g., output evaluator 132) for the purpose of receiving input from a user/developer to an interactive element directly outside the interactive environment (e.g., interactive environment 140). In some instances, as shown in portal 300 the portal is a chat window, although other embodiments, such as a small-scale version of the interactive environment where other inputs than text (e.g., audio, visual, interactive element status, etc.) may be received and processed by the DS (e.g., DS 120) according to aspects described herein. In examples, the portal may have an introductory message 302 that provides some context for the user/developer on the situation. Additionally, there may be an advisory and/or warning message 304 informing the user/developer that they are interacting with a ML model in a training environment and may see potentially offensive and/or inappropriate responses as the ML model is being trained. In this instances the portal 300 is a chat window with text input field 312 for display of messages 306, 308, and 310. Messages 306 and 308 are generated in association with an interactive element of an interactive environment 140, in this instance an NPC. The portal 300 may have one or more selectable controls such as end button 314 for further interaction with the portal and/or interaction with an interactive element which may be further based on the selectable controls available to the user/developer in the interactive environment.

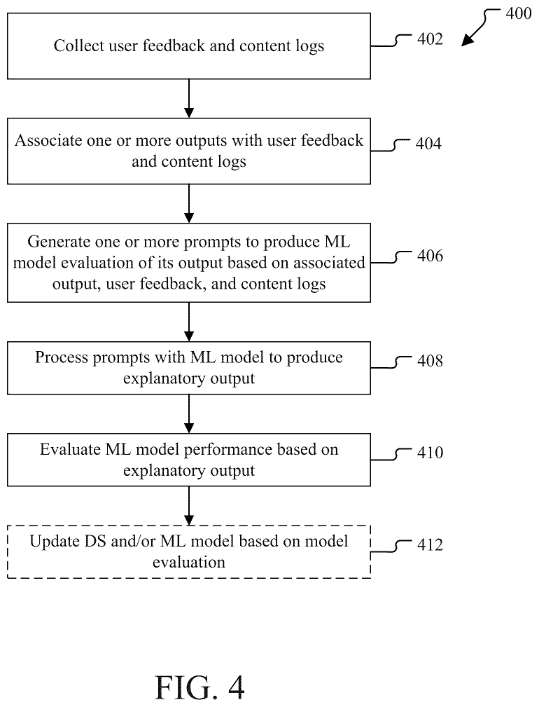

FIG. 4 is a block diagram illustrating a method of evaluating a ML model output using the ML model to provide the evaluation of its own output, according to aspects described herein. A general order of the operations for the method 400 is shown in FIG. 4. Generally, the method 400 begins with operation 402 and ends with operation 412. The method 400 may include more or fewer steps or may arrange the order of the steps differently than those shown in FIG. 4. The method 400 can be executed as computer-executable instructions executed by a computer system and encoded or stored on a computer readable medium or other non-transitory computer storage media. Further, the method 400 can be performed by gates or circuits associated with a processor, an ASIC, an FPGA, a SOC or other hardware device. Hereinafter, the method 400 shall be explained with reference to the systems, components, devices, modules, software, data structures, data characteristic representations, signaling diagrams, methods, etc., described in conjunction with FIGS. 1, 2, 3, 5A, 5B, 6, 7, and 8.

At operation 402, user/developer feedback and/or content logs may be obtained by an output evaluator (e.g., output evaluator 132) from a data store (e.g., data store 112) and/or integration manager (e.g., integration manager 106). At operation 404, the output evaluator may associate one or more ML model outputs with user/developer feedback and content logs from the interactive environment 140. In some examples, at operation 404 the one or more ML model outputs and user with user/developer feedback and content logs may be previously associated and stored in a data store (e.g., data store 106). At operation 406, a prompt generator (e.g., prompt generator 128) may generate one or more prompts for an ML model based on the associated output, user/developer feedback, and/or content logs. At operation 408, the ML model may process the one or more prompts to produce explanatory output of its previous behavior as a means of the developer gaining understanding of the ML models previous outputs and actions. At operation 410, the ML model performance may be evaluated by the output evaluator (e.g., output evaluator 132) in some cases by generating a confidence score for one or more components of the output and comparing the one or more confidence scores to a threshold value. The confidence score may be determined using evaluation metrics developed for the ML model and the output. The confidence score may be a measure of the output's responsiveness to the input and how well the output satisfies the environment guidelines based on the one or more evaluation metrics. At optional operation 412, the DS (e.g., DS 120) and/or ML model may be updated based on the model evaluation outcome from operation 410. Operation 412 is shown with a dashed box, to indicate that it is optional.

FIGS. 5A and 5B illustrate overviews of an example generative machine learning model that may be used according to aspects described herein. With reference first to FIG. 5A, conceptual diagram 500 depicts an overview of pre-trained generative model package 504 that processes an input and a prompt 502 to generate model output 506 aspects described herein.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that input 502 includes a prompt that is generated, selected, or otherwise engineered to induce generative model package 504 to produce certain generative model output 506. It will be appreciated that input 502 and generative model output 506 may each include any of a variety of content types, including, but not limited to, text output, image output, audio output, video output, programmatic output, and/or binary output, among other examples. In examples, input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2, 3, and 4). Accordingly, generative model package 504 operates as a tool with which machine learning processing is performed, in which certain inputs 502 to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., user device 102 in FIG. 1) or may be accessed remotely from a machine learning service (e.g., director service 120). In other examples, aspects of generative model package 504 are distributed across multiple computing devices. In some instances, generative model package 504 is accessible via an application programming interface (API), as may be provided by an operating system of the computing device and/or by the machine learning service, among other examples.

With reference now to the illustrated aspects of generative model package 504, generative model package 504 includes input tokenization 508, input embedding 510, model layers 512, output layer 514, and output decoding 516. In examples, input tokenization 508 processes input 502 to generate input embedding 510, which includes a sequence of symbol representations that corresponds to input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes input and prompt for generation 502 (e.g., corresponding to a skill of a skill chain).

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects.

Accordingly, output probabilities 596 may thus form model output 506 according to aspects described herein, such that the output of the generative ML model defines an output corresponding to the input. For instance, model output 506 may be associated with an interactive element of the interactive environment 140, among other examples.

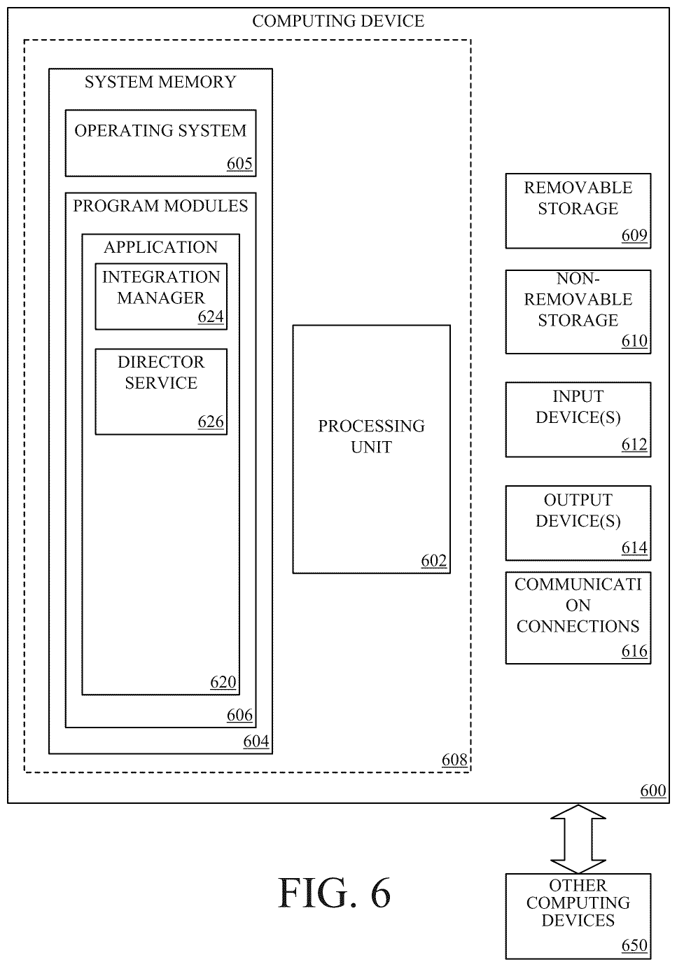

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including user device 102 in FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store integration manager 624 and/or director service 626. The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

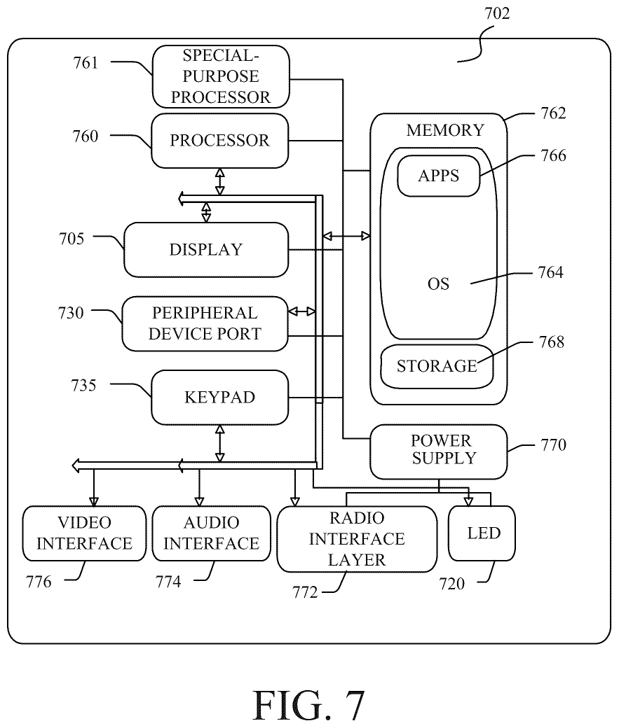

FIG. 7 is a block diagram illustrating the architecture of one aspect of a computing device. That is, the computing device can incorporate a system (e.g., an architecture) 702 to implement some aspects. In some examples, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., an embedding object memory insertion engine, an embedding object memory retrieval engine, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and/or special-purpose processor 761 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A computing device implementing the system 702 may have additional features or functionality. For example, the computing device may also include additional data storage devices (removable and/or non-removable) such as, magnetic disks, optical disks, or tape. Such additional storage is illustrated in FIG. 7 by the non-volatile storage area 768.

Data/information generated or captured by the computing device and stored via the system 702 may be stored locally on the computing device, as described above, or the data may be stored on any number of storage media that may be accessed by the device via the radio interface layer 772 or via a wired connection between the computing device and a separate computing device associated with the computing device, for example, a server computer in a distributed computing network, such as the Internet. As should be appreciated such data/information may be accessed via the computing device via the radio interface layer 772 or via a distributed computing network. Similarly, such data/information may be readily transferred between computing devices for storage and use according to well-known data/information transfer and storage means, including electronic mail and collaborative data/information sharing systems.

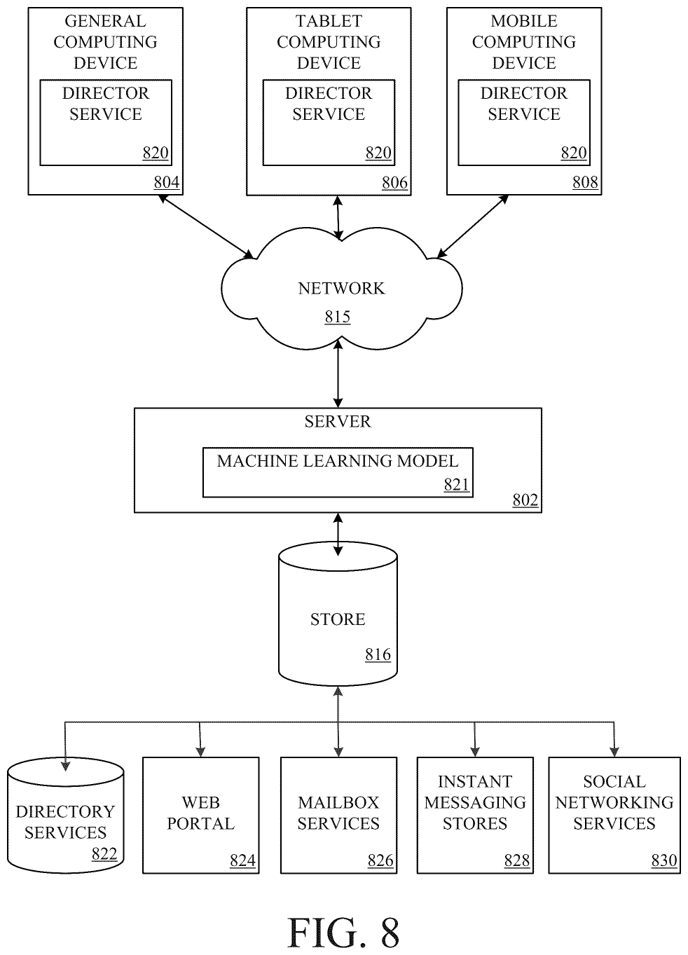

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

An director service 820 (e.g., similar to the application 620) may be employed by a client that communicates with server device 802. Additionally, or alternatively, embedding object memory insertion engine 821 and/or embedding object memory retrieval engine 822 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

As will be understood from the foregoing disclosure, one aspect of the technology relates to a system comprising: at least one processor; and memory storing instructions that, when executed by the at least one processor, cause the system to perform a set of operations. The set of operations comprises: receive an input, by a director service, to modify an interactive element of an interactive environment; analyze, by the director service, the interactive environment for a specific context based on the input; receive one or more environment guidelines; associate, by the director service, the input with one or more environment guidelines that provide systemic context about the interactive environment; determine, by the director service, a intent objective based on one or more of the input, specific context and one or more environment guidelines; generate, by the director service, a prompt for a generative machine learning model based on the intent objective; execute the generative machine learning model with the prompt to produce a model output; evaluate, by the director service, the model output for responsiveness to the input and the environment guidelines; and when the model output is responsive, modify the interactive element of the interactive environment based on the model output. In an example, the set of operations further comprises: monitor the interactive environment for a subsequent input based on the provided model output; when there is a subsequent input, analyze, by the director service, the interactive environment for a specific context based on the subsequent input; associate the subsequent input with one or more environment guidelines that provide systemic context about the interactive environment; determine a second intent objective based on one or more of the subsequent input, specific context and one or more environment guidelines; and generate a second prompt for the generative machine learning model based on the intent objective. In another example, generate a prompt further comprises: associate one or more prompt templates with the intent objective; and combine the one or more prompt templates into a prompt. In a further example, associate one or more prompt templates further comprises: generate an embedding for the intent objective; and identify one or more prompt templates that are semantically associated with the intent objective based on the embedding. In yet another example, generate a intent objective further comprises: generate an embedding for one or more of the input, specific context, and environment guidelines; and identify a intent objective that is semantically associated with the input, specific context, and environment guidelines based on the intent objective. In a further still example, evaluate the model output for responsiveness further comprises: receive a confidence threshold value for evaluating model output; generate one or more confidence scores for one or more components of the model output, wherein the confidence score measures responsiveness to the input and satisfying the environment guidelines based on one or more metrics; and compare the one or more confidence scores for the one or more components of the output against the confidence threshold value. In another example, the set of operations further comprises: store one or more of the input, the one or more intent objectives, the prompt, and the model output. In a further example, when the model output is not responsive, the set of operations further comprises: generate a new prompt for the generative machine learning model based on the intent objective; and execute the generative machine learning model with the new prompt to produce a new model output.

In another aspect, the technology relates to a method, comprising: receiving an input to modify an interactive element of a gaming environment; analyzing the gaming environment for a specific context based on the input; receiving one or more environment guidelines; associating the input with one or more environment guidelines that provide systemic context about the gaming environment; determining a intent objective based on one or more of the input, specific context and one or more environment guidelines; generating a prompt for a generative machine learning model based on the intent objective; executing the generative machine learning model with the prompt to produce a model output; evaluating the model output for responsiveness to the input and the environment guidelines; and when the model output is responsive, modifying the interactive element of the gaming environment based on the model output. In an example, the method further comprises: monitoring the interactive environment for a subsequent input based on the provided model output; when there is a subsequent input, analyzing the gaming environment for a specific context based on the subsequent input; associating the subsequent input with one or more environment guidelines that provide systemic context about the gaming environment; determining a second intent objective based on one or more of the subsequent input, specific context and one or more environment guidelines; and generating a second prompt for the generative machine learning model based on the intent objective. In another example, generating a prompt further comprises: associating one or more prompt templates with the intent objective; and combining the one or more prompt templates into a prompt. In a further example, associating one or more prompt templates further comprises: generating an embedding for the intent objective; and identifying one or more prompt templates that are semantically associated with the intent objective based on the embedding. In yet another example, generating an intent objective further comprises: generating an embedding for one or more of the input, specific context, and environment guidelines; and identifying a intent objective that is semantically associated with the input, specific context, and environment guidelines based on the intent objective. In a further still example, evaluating the model output for responsiveness further comprises: receiving a confidence threshold value for evaluating model output; generating one or more confidence scores for one or more components of the model output, wherein the confidence score measures responsiveness to the input and satisfying the environment guidelines based on one or more metrics; and comparing the one or more confidence score for the one or more components of the output against the confidence threshold value. In another example, the method further comprises storing one or more of the input, intent objective, the prompt, and the model output. In a further example, when the model output is not responsive, the method further comprises: generating a new prompt for the generative machine learning model based on the intent objective; and executing the generative machine learning model with the new prompt to produce a new model output. In yet another example, an interactive element comprises a non-player character (NPC), animated infographic, video, image, quiz, game object, and other aspects of the gaming environment which a user may be able to access and interact with. In a further still example, a gaming environment comprises a video game, online game, MMORPG, and a virtual reality environment.

In a further aspect, the technology relates to computer storage media including instructions, which when executed by a processor, cause the processor to: receive an input to modify an interactive element of an interactive environment; analyze the interactive environment for a specific context based on the input; receive one or more environment guidelines; associate the input with one or more environment guidelines that provide systemic context about the interactive environment; determine a intent objective based on one or more of the input, specific context and one or more environment guidelines; generate a prompt for a generative machine learning model based on the intent objective; execute the generative machine learning model with the prompt to produce a model output; evaluate the model output for responsiveness to the input and the environment guidelines; and when the model output is responsive, modify the interactive element of the interactive environment based on the model output. In an example, when the model output is not responsive, the processor is further caused to: generate a new prompt for the generative machine learning model based on the intent objective; and execute the generative machine learning model with the new prompt to produce a new model output.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
receive an input, by a director service, to modify an interactive element of an interactive environment;
analyze, by the director service, the interactive environment for a specific context based on the input;
receive one or more environment guidelines;
associate, by the director service, the input with one or more environment guidelines that provide systemic context about the interactive environment;
determine, by the director service, a intent objective based on one or more of the input, specific context and one or more environment guidelines;
generate, by the director service, a prompt for a generative machine learning model based on the intent objective;
execute the generative machine learning model with the prompt to produce a model output;
evaluate, by the director service, the model output for responsiveness to the input and the environment guidelines; and
when the model output is responsive, modify the interactive element of the interactive environment based on the model output.

2. The system of claim 1, wherein the set of operations further comprises:
monitor the interactive environment for a subsequent input based on the provided model output;
when there is a subsequent input, analyze, by the director service, the interactive environment for a specific context based on the subsequent input;
associate the subsequent input with one or more environment guidelines that provide systemic context about the interactive environment;
determine a second intent objective based on one or more of the subsequent input, specific context and one or more environment guidelines; and
generate a second prompt for the generative machine learning model based on the intent objective.

3. The system of claim 1, wherein generate a prompt further comprises:
associate one or more prompt templates with the intent objective; and
combine the one or more prompt templates into a prompt.

4. The system of claim 3, wherein associate one or more prompt templates further comprises:
generate an embedding for the intent objective; and
identify one or more prompt templates that are semantically associated with the intent objective based on the embedding.

5. The system of claim 1, wherein generate a intent objective further comprises:
generate an embedding for one or more of the input, specific context, and environment guidelines; and
identify a intent objective that is semantically associated with the input, specific context, and environment guidelines based on the intent objective.

6. The system of claim 1, wherein evaluate the model output for responsiveness further comprises:
receive a confidence threshold value for evaluating model output;
generate one or more confidence scores for one or more components of the model output, wherein the confidence score measures responsiveness to the input and satisfying the environment guidelines based on one or more metrics; and
compare the one or more confidence scores for the one or more components of the output against the confidence threshold value.

7. The system of claim 1, wherein the set of operations further comprises:
store one or more of the input, the one or more intent objectives, the prompt, and the model output.

8. The system of claim 1, when the model output is not responsive, the set of operations further comprises:
generate a new prompt for the generative machine learning model based on the intent objective; and
execute the generative machine learning model with the new prompt to produce a new model output.

9. A method comprising:
receiving an input to modify an interactive element of a gaming environment;
analyzing the gaming environment for a specific context based on the input;
receiving one or more environment guidelines;
associating the input with one or more environment guidelines that provide systemic context about the gaming environment;
determining a intent objective based on one or more of the input, specific context and one or more environment guidelines;
generating a prompt for a generative machine learning model based on the intent objective;
executing the generative machine learning model with the prompt to produce a model output;
evaluating the model output for responsiveness to the input and the environment guidelines; and
when the model output is responsive, modifying the interactive element of the gaming environment based on the model output.

10. The method of claim 9, further comprising:
monitoring the interactive environment for a subsequent input based on the provided model output;
when there is a subsequent input, analyzing the gaming environment for a specific context based on the subsequent input;
associating the subsequent input with one or more environment guidelines that provide systemic context about the gaming environment;
determining a second intent objective based on one or more of the subsequent input, specific context and one or more environment guidelines; and
generating a second prompt for the generative machine learning model based on the intent objective.

11. The method of claim 9, wherein generating a prompt further comprises:
associating one or more prompt templates with the intent objective; and
combining the one or more prompt templates into a prompt.

12. The method of claim 11, wherein associating one or more prompt templates further comprises:
generating an embedding for the intent objective; and
identifying one or more prompt templates that are semantically associated with the intent objective based on the embedding.

13. The method of claim 9, wherein generating an intent objective further comprises:
generating an embedding for one or more of the input, specific context, and environment guidelines; and
identifying a intent objective that is semantically associated with the input, specific context, and environment guidelines based on the intent objective.

14. The method of claim 9, wherein evaluating the model output for responsiveness further comprises:
receiving a confidence threshold value for evaluating model output;
generating one or more confidence scores for one or more components of the model output, wherein the confidence score measures responsiveness to the input and satisfying the environment guidelines based on one or more metrics; and
comparing the one or more confidence score for the one or more components of the output against the confidence threshold value.

15. The method of claim 9, further comprising:
storing one or more of the input, intent objective, the prompt, and the model output.

16. The method of claim 9, when the model output is not responsive, the method further comprises:
generating a new prompt for the generative machine learning model based on the intent objective; and
executing the generative machine learning model with the new prompt to produce a new model output.

17. The method of claim 9, wherein an interactive element comprises a non-player character (NPC), animated infographic, video, image, quiz, game object, and other aspects of the gaming environment which a user may be able to access and interact with.

18. The method of claim 9, wherein a gaming environment comprises a video game, online game, MMORPG, and a virtual reality environment.

19. A computer storage media including instructions, which when executed by a processor, cause the processor to:
receive an input to modify an interactive element of an interactive environment;
analyze the interactive environment for a specific context based on the input;
receive one or more environment guidelines;
associate the input with one or more environment guidelines that provide systemic context about the interactive environment;
determine a intent objective based on one or more of the input, specific context and one or more environment guidelines;
generate a prompt for a generative machine learning model based on the intent objective;
execute the generative machine learning model with the prompt to produce a model output;
evaluate the model output for responsiveness to the input and the environment guidelines; and
when the model output is responsive, modify the interactive element of the interactive environment based on the model output.

20. The computer storage media of claim 19, when the model output is not responsive, the processor is further caused to:
generate a new prompt for the generative machine learning model based on the intent objective; and
execute the generative machine learning model with the new prompt to produce a new model output.
